(19) United States
(12) Patent Application Publication
(10) Pub. No.: US 2024/0316574 A1
(43) Pub. Date: Sep. 26, 2024

(54) SPINDLE FLOW TYPE NOZZLE

(71) Applicants: PING-YEN CHUANG, HSINCHU CITY (TW); YUNG-LAN CHUANG, HSINCHU CITY (TW)

(72) Inventors: PING-YEN CHUANG, HSINCHU CITY (TW); YUNG-LAN CHUANG, HSINCHU CITY (TW)

(21) Appl. No.: 18/450,726

(22) Filed: Aug. 16, 2023

(30) Foreign Application Priority Data
Mar. 20, 2023 (TW) 112110294

(51) Int. Cl. B05B 1/06; B05B 1/26

(52) U.S. Cl. CPC B05B 1/06; B05B 1/265

(57) ABSTRACT

This invention is a spindle flow type nozzle comprising a tube body and a partition member, wherein the partition member is located within an accommodating space of the tube body. The tube body includes an inner wall, an inlet and an outlet, while the partition member includes a middle ring area, a first convex body, and a second convex body. The inner wall connecting to the outlet is defined as an outlet-side inner wall that extends with an outlet-side thickening angle towards the centerline of the outlet or tube body. A converging space is formed between the first convex body and the inlet-side inner wall, while a diverging space is formed between the second convex body and the outlet-side inner wall. A passage is formed between the middle ring area and the inner wall for connecting the converging space and the diverging space.

### CROSS-REFERENCE TO RELATED APPLICATIONS

This non-provisional application claims priority claim under 35 U.S.C. § 119(a) on Taiwan Patent Application No. 112110294 filed Mar. 20, 2023, the entire contents of which are incorporated herein by reference.

### TECHNICAL FIELD

This invention is a spindle flow type nozzle that is suitable for high-precision jet heads, drug delivery devices, medical aesthetic devices, or jet engines. It is capable of generating a more concentrated supersonic fluid flow.

### BACKGROUND

The DeLaval nozzle, also known as a convergent-divergent nozzle, is capable of converting the thermal energy of the inlet fluid into kinetic energy and generating supersonic jet flow. As shown in FIG. 1, the DeLaval nozzle 10 is a tapered tube body 12 with a contracted middle section and an hourglass shape at both ends. The DeLaval nozzle 10 has an inlet 11 at one end, an outlet 13 at the other end, and a throat 17 located between the inlet 11 and the outlet 13 is the section of smallest cross-sectional area. The space from the inlet 11 to the throat 17, between the inner wall 15, forms a converging space 115 with gradually decreasing cross-sectional area. The space from the throat 17 to the outlet 13, also between the inner wall 15, forms a diverging space 135 with gradually increasing cross-sectional area. The inlet fluid F1, which is at a higher pressure than the ambient pressure, will be accelerated as it passes through the converging space 115 and reaches the speed of sound (Mach number=1.0) at the throat 17. As the inlet fluid F1 flows from the throat 17 to the diverging space 135, the gas begins to expand, resulting in the jet flow F2 expelled from the outlet 13 having a velocity greater than the speed of sound (Mach number>1.0).

The DeLaval nozzle 10 is widely used in steam turbines, rocket engines, supersonic jet engines, jet propulsion systems, and/or biomedical delivery devices. However, the DeLaval nozzle 10 has a divergent type of outlet 13, and when the jet flow F2 or the delivered object is expelled from the outlet 13 at supersonic speeds, it continues to disperse outward instead of concentrating in the intended delivery area. Additionally, it will generate a significant sonic boom at the outlet 13.

### SUMMARY

Thus, the objective of the present invention is to propose a spindle flow type nozzle that can improve the problem of excessively divergent airflow from a Devala nozzle. The spindle flow type nozzle not only generates a more concentrated outlet fluid but also reduces the sound intensity at the outlet of the nozzle.

To achieve the object, this invention provides a spindle flow type nozzle, comprising: a tube body comprising an inner wall, an inlet and an outlet, and a accommodating space formed between the inner wall, the inlet and the outlet, wherein the inner wall adjacent to a middle position of the tube body is defined as a middle section area, and an inlet-side inner wall and an outlet-side inner wall are respectively located two sides of the middle section area, wherein the outlet-side inner wall extends from the middle section area towards a center point or a centerline of the outlet at an outlet-side thickening angle; and a partition member located within the accommodating space of the tube body, the partition member adjacent to a middle position thereof being defined as a middle ring area, and a first convex body and a second convex body respectively located two sides of the middle ring area, wherein the first convex body faces the inlet of the tube body to forms a converging space between the first convex body and the inlet-side inner wall, and a cross-sectional area of the converging space gradually decreases from the inlet towards the outlet, wherein the second convex body faces the outlet of the tube body to form a diverging space between the second convex body and the outlet-side inner wall, and the cross-sectional area of the diverging space gradually increases from the inlet towards the outlet, wherein at least one passage is formed between the middle ring area and the inner wall to connect the converging space and the diverging space.

This invention further provides another spindle flow type nozzle, comprising: a tube body comprising an inner wall, an inlet and an outlet, and a accommodating space formed between the inner wall, the inlet and the outlet, wherein the inner wall adjacent to a middle position of the tube body is defined as a middle section area, and an inlet-side inner wall and an outlet-side inner wall are respectively located two sides of the middle section area; a partition member located within the accommodating space of the tube body, the partition member adjacent to a middle position thereof being defined as a middle ring area, and a first convex body and a second convex body respectively located two sides of the middle ring area, wherein the first convex body faces the inlet of the tube body to forms a converging space between the first convex body and the inlet-side inner wall, and a cross-sectional area of the converging space gradually decreases from the inlet towards the outlet, wherein the second convex body faces the outlet of the tube body to form a diverging space between the second convex body and the outlet-side inner wall, and the cross-sectional area of the diverging space gradually increases from the inlet towards the outlet, wherein at least one passage is formed between the middle ring area and the inner to connect the converging space and the diverging space; and a connecting member located within the converging space, and connecting the inlet-side inner wall and the first convex body.

Therefore, this invention has at least the following advantages:
1. The inner wall of the outlet has an outlet-side thickening angle, which generates a concentrated outlet fluid and facilitates the projection of the outlet fluid and delivered objects to the desired location.
2. The inner wall of the outlet has an outlet-side thickening angle, which not only reduces the startup pressure of the output fluid but also reduces the intensity of the sound burst formed at the outlet.
3. A connecting member is positioned within the converging space and connects the tube body and the partition member, reducing interference from the connecting member during the acceleration process of the inlet fluid and improving the velocity of the outlet fluid.
4. A spindle flow type nozzle with an inlet-side thinning and an outlet-side thinning angle is provided to reduce the manufacturing difficulties of the nozzle.

### BRIEF DESCRIPTION OF THE DRAWINGS

This disclosure will become more fully understood from the detailed description given herein below for illustration only, and thus not limitative of this disclosure, wherein:

FIG. 1 is a schematic cross-sectional view of a conventional DeLaval nozzle.

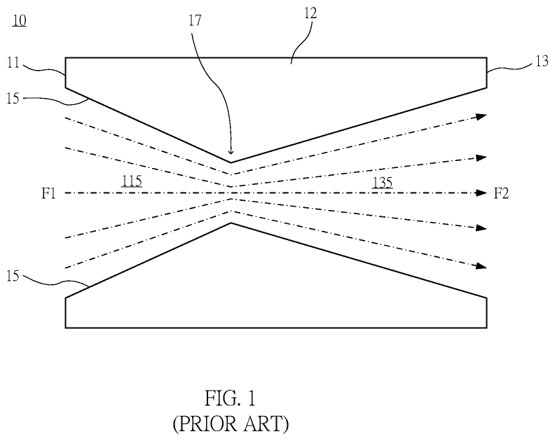

FIG. 2 is a schematic cross-sectional view of the spindle flow type nozzle according to a preferred embodiment of the invention.

FIG. 3 is a side view of an inlet of the embodiment shown in FIG. 2.

FIG. 4 is a schematic cross-sectional view of the spindle flow type nozzle according to another embodiment of the invention.

FIG. 5 is a schematic cross-sectional view of the spindle flow type nozzle according to another embodiment of the invention.

FIG. 6 is a side view of the inlet of the embodiment shown in FIG. 5.

FIG. 7 is a schematic cross-sectional view of the spindle flow type nozzle according to another embodiment of the invention.

FIG. 8 is a schematic cross-sectional view of the spindle flow type nozzle according to another embodiment of the invention.

### DETAILED DESCRIPTION

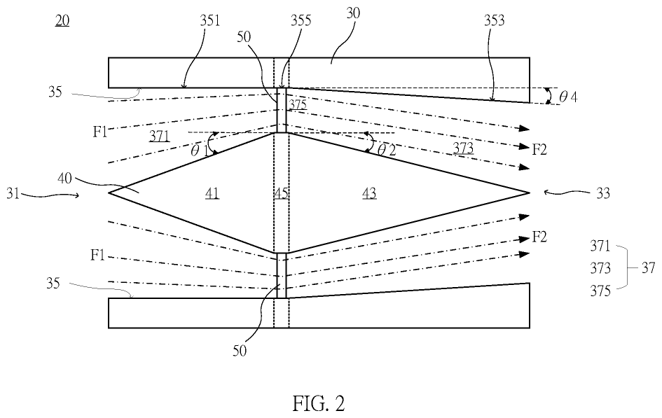

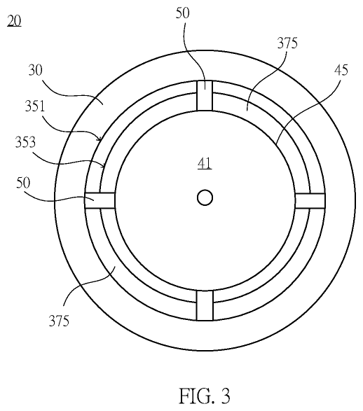

FIG. 2 is a schematic cross-sectional view of the spindle flow type nozzle according to a preferred embodiment of the invention, and FIG. 3 is a side view of an inlet of the embodiment shown in FIG. 2. The spindle flow type nozzle 20 comprises a tube body 30 and a partition member 40, and is capable of converting the thermal energy of an inlet fluid into kinetic energy and generating supersonic jet flow. The tube body 30 includes an inner wall 35, an inlet 31 and an outlet 33, and a accommodating space 37 is formed between the inner wall 35, the inlet 31 and the outlet 33. The inner wall 35 adjacent to a middle position of the tube body 30 may be defined as a middle section area 355. The inner wall 35 between the middle section area 355 and the inlet 31 may be defined as an inlet-side inner wall 351, while the inner wall 35 between the middle section area 355 and the outlet 33 is defined as an outlet-side inner wall 353. The outlet-side inner wall 353 slopes and extends from the middle section area 355 towards the direction of the center point or centerline of the outlet 33 and/or the tube body 30 at an outlet-side thickening angle θ4. This design causes the distance or cross-sectional area of the outlet-side inner wall 353 to gradually decrease in the direction towards the outlet 33, or the thickness of the tube body 30 to gradually increase in the direction towards the outlet 33.

The partition member 40 is located within the accommodating space 37. The partition member 40 adjacent to a middle position thereof may be defined as a middle ring area 45. On either side of the middle ring area 45, a first convex body 41 and a second convex body 43 are respectively located. For example, the partition member 40 may approximate a spindle shape, an elliptical shape, an olive shape, a cone shape, or a frustum shape. The first convex body 41 faces the inlet 31 of the tube body 30 and extends from the middle ring area 45 towards the center point or centerline of the inlet 31 and/or the tube body 30 at a first inclined angle θ1. Between the first convex body 41 and the inlet-side inner wall 351, a converging space 371 is formed, with its cross-sectional area gradually reducing in the direction from the inlet 31 towards the outlet 33. The second convex body 43 faces the outlet 33 of the tube body 30 and extends from the middle ring area 45 towards the center point or centerline of the outlet 33 and/or the tube body 30 at a second inclined angle θ2. Between the second convex body 43 and the outlet-side inner wall 353, a diverging space 373 is formed, with its cross-sectional area gradually increasing in the direction from the inlet 31 towards the outlet 33.

At least one passage 375 is formed between the middle ring area 45 of the partition member 40 and the inner wall 35, for example the passage 375 may be arranged around the middle ring area 45 and arranged in a ring shape. The passage 375 is able to connect the converging space 371 and the diverging space 373. In practical applications, an inlet fluid F1 with a pressure higher than the ambient pressure can be delivered from the inlet 31 to the converging space 371. The inlet fluid F1 will be divided by the first convex body 41. As the inlet fluid F1 passes through the smallest cross-sectional area of the passage 375, its velocity reaches the speed of sound (Mach 1). The fluid then enters the diverging space 373 through the passage 375 and continues to increase in speed between the second convex body 43 and the outlet-side inner wall 353, ultimately being expelled at supersonic speed (>Mach 1) from the outlet 33 as the outlet fluid F2. By incorporating the outlet-side inner wall 353 with an outlet-side thickening angle θ4 and the arrangement of the partition member 40, the outlet fluid F2 expelled from the outlet 33 becomes more concentrated. For example, when the area of outlet 33 in this invention is the same as the area of outlet 13 in the DeLaval nozzle 10, the spray area of the outlet fluid F2 sprayed from outlet 33 in this invention will be smaller than the spray area of the fluid sprayed from outlet 13 in the DeLaval nozzle 10.

In the embodiments shown in FIG. 2 and FIG. 3, the partition member 40 may be connected to the tube body 30 through at least one connecting member 50. For example, the connecting member 50 may be a connecting rod for connecting the middle ring area 45 of the partition member 40 and the middle section area 355 of the tube body 30, thereby forming at least one passage 375 between the connecting member 50, the middle section area 355 of the tube body 30, and the middle ring area 45 of the partition member 40.

The second inclined angle θ2 of the partition member 40 is greater than the outlet-side thickening angle θ4 of the outlet-side inner wall 353 to ensure that the cross-sectional area of the diverging space 373 gradually increases in the direction from the inlet 31 towards the outlet 33. For example, the outlet-side thickening angle θ4 may range from 0 degrees to 10 degrees.

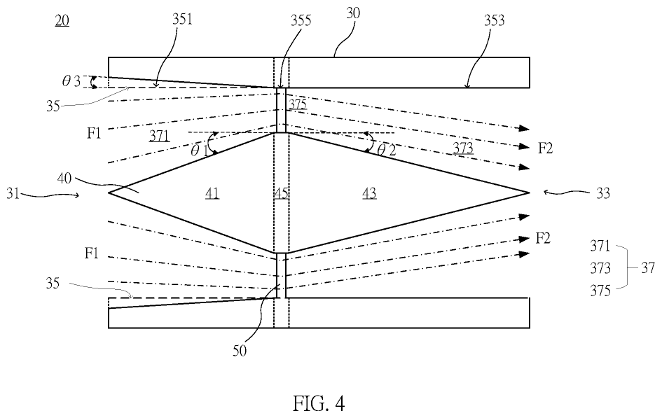

FIG. 4 is a cross-sectional schematic diagram of the spindle divergent nozzle according to another embodiment of the invention. The outlet-side thickening angle θ4 may be 0 degrees, and the cross-sectional area of the outlet-side inner wall 353 remains the same from the inlet 31 towards the outlet 33, while the cross-sectional area of the diverging space 373 gradually increases in the direction from the inlet 31 towards the outlet 33.

In one embodiment of the invention, the inlet-side inner wall 351 has an inlet-side thinning angle θ3. The inlet-side inner wall 351 extends from the middle section area 355 of the inner wall 35 towards the direction away from the center point or centerline of the inlet 31 and/or the tube body 30 at an inlet-side thinning angle θ3. This design causes the distance or cross-sectional area of the inlet-side inner wall 351 to gradually increase towards the inlet 31, or the thickness of the tube body 30 to gradually reduce in the direction towards the inlet 31. The cross-sectional area of the converging space 371 gradually decreases in the direction from the inlet 31 towards the outlet 33.

In experimental data of the invention, when the outlet-side thickening angle θ4 is 0 degrees and a startup pressure of the inlet fluid F1 is 80 psi (pound-force per square inch), the velocity of the outlet fluid F2 at the outlet 33 is approximately 2.42 Mach, and the spray area of the outlet fluid F2 is approximately 50.27 mm². Conversely, when the outlet-side thickening angle θ4 is 0.63 degrees and the startup pressure of the inlet fluid F1 is 80 psi, the velocity of the outlet fluid F2 at the outlet 33 is approximately 2.06 Mach, and the spray area of the outlet fluid F2 is approximately 28.27 mm². From the above experiments, it can be seen that in the embodiments of the invention, the spindle flow type nozzle 20 can generate supersonic outlet fluid F2 when the startup pressure of the inlet fluid F1 exceeds the ambient pressure. Furthermore, when the outlet-side thickening angle θ4 is smaller than the second inclined angle θ2, a concentrated outlet fluid F2 can be achieved, making the spindle floe type nozzle 20 particularly suitable for precise delivery of objects or concentrated outlet fluid F2.

In another embodiment of the invention, if the outlet-side thickening angle θ4 is 0 degrees, the startup pressure of the inlet fluid F1 must exceed 70 psi to generate supersonic outlet fluid F2 (2.41 Mach) at the outlet 33. Conversely, if the outlet-side thickening angle θ4 is 0.63 degrees, the startup pressure of the inlet fluid F1 only needs to exceed 50 psi to generate supersonic outlet fluid F2 (2.02 Mach) at the outlet 33. Moreover, when the outlet-side thickening angle θ4 is 0.63 degrees and the startup pressure of the inlet fluid F1 is 70 psi, the outlet fluid F2 with a velocity of 2.05 Mach can be generated at the outlet 33. Therefore, when the outlet-side thickening angle θ4 of the outlet-side inner wall 353 exceeds 0 degrees, the required startup pressure of the inlet fluid F1 will be lower than that of the outlet-side inner wall 353 with θ4 equal to 0 degrees.

The sonic boom volume of the outlet-side inner wall 353 with the out-side thickening angle θ4 of 0.63 degrees is approximately 10 decibels (dB) lower than the outlet-side inner wall 353 with the out-side thickening angle θ4 of 0 degrees. Furthermore, compared to the conventional DeLaval nozzle's divergent wide nozzle, the invention's spindle flow type nozzle 20 with a thickened outlet end angle θ4 can significantly reduce the sonic boom volume.

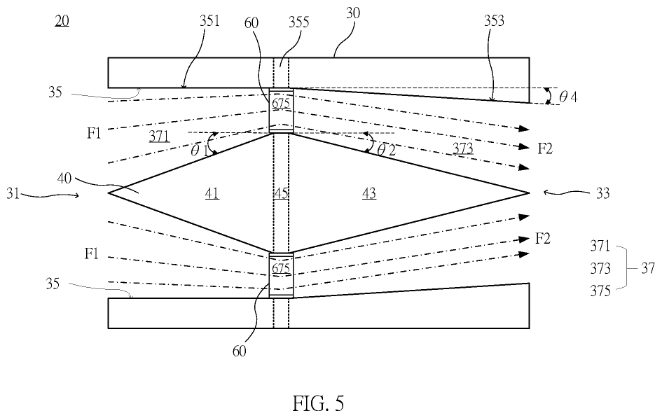

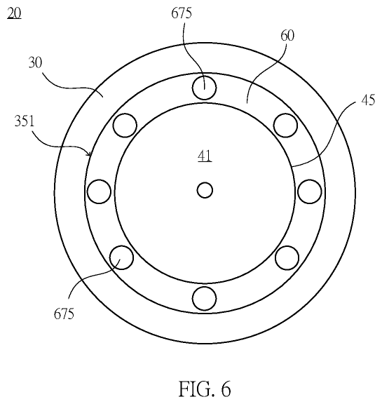

FIG. 5 is a cross-sectional schematic diagram of the spindle divergent nozzle according to another embodiment of the invention. FIG. 6 is a side view of the inlet of the embodiment shown in FIG. 5. The fixing ring 60 is a ring-shaped structure or a hollow column and is arranged around the outer side of the partition member 40. The outer diameter of the fixing ring 60 is slightly smaller than or equal to the inner diameter of the middle section area 355, and it can secure the partition member 40 to the inner wall 35 of the tube body 30. Specifically, the partition member 40 can be connected to the radial inside of the fixing ring 60, and the partition member 40 and the fixing ring 60 can be placed in the accommodating space 37 of the tube body 30, allowing the fixing ring 60 to be secured to the inner wall 35 of the tube body 30. The fixing ring 60 includes at least one passage 675, wherein the passage 675 communicates with the converging space 371 and the diverging space 373. The inlet fluid F1 in the converging space 371 can flow through the passage 675 to the diverging space 373 and form a supersonic outlet fluid F2 at the outlet 33.

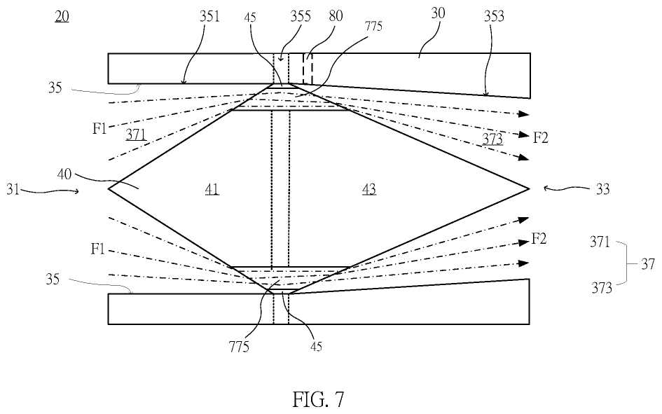

FIG. 7 is a cross-sectional schematic diagram of the spindle flow type nozzle according to another embodiment of the invention. In this embodiment, at least one passage 775 can be disposed on the position adjacent to the middle ring area 45 of the partition member 40. The inlet fluid F1 in the converging space 371 can flow through the passage 775 to the diverging space 373. In one embodiment of the invention, the partition member 40 and the fixing ring 60 shown in FIG. 5 and FIG. 6 may be integrated into a unified molded structure, so that the middle ring area 45 of the partition member 40 has a protruding ring-shaped structure, and the middle ring area 45 of the partition member 40 can directly contact and fix to the inner wall 35 of the tube body 30. In another embodiment of the invention, the passage 775 may be directly provided on the middle ring area 45 of the partition member 40.

In one embodiment of the invention, an feed hole 80 is provided on the tube body 30, wherein the feed hole 80 penetrates through the tube body 30 and the inner wall 35 and connects to the accommodating space 37. In practical applications, a delivery object can be transported to the accommodating space 37 through the feed hole 80. For example, the delivery object may include a solution or metal particles. The inlet fluid F1 entering through the inlet 31 accelerates within the converging space 371, the passage 775, and/or the diverging space 373, and is used to drive or propel the delivery object within the accommodating space 37, transporting it to the diverging space 373 and exiting through the outlet 33 of the nozzle 20. The delivery object and the outlet fluid F2 exiting the outlet 33 have a relatively high velocity, such as supersonic speed, and can be used to penetrate a target object, such as skin tissue or cellular tissue. The spindle flow type nozzle 20 of the invention is suitable for a drug delivery device, particularly in the fields of medical or cosmetic treatments. Through the use of the spindle flow type nozzle 20 of the invention, high-speed gas can instantly atomize drugs or skincare products, allowing for even distribution and better penetration and absorption into the user's skin compared to traditional application methods.

The delivery object can be a subcutaneous filler, a tissue growth stimulant, a botulinum toxin, a biological substance, a medication, a skincare product, a polymer particle, or a crystalline ceramic, for example, but not limited to DNA, RNA, proteins, cosmetic compositions, minerals, viral particles, botulinum toxin, uric acid, activated gels, collagen proteins, vitamins, cellulose, fruit acids, gene transplants, vaccines, essences, pearls, precious metals, platelets, pain-relieving genes, and/or reducing pigments.

In one embodiment of the invention, the feed hole 80 may be connected to the converging space 371, the passage 775/675/375, or the diverging space 373. Specifically, better results are achieved when the feed hole 80 is connected to the passage 775 or the diverging space 373 because the inlet fluid F1 will have a higher flow velocity when passing through these sections, facilitating the propulsion of DNA solution or metal particles containing DNA by the high-speed fluid.

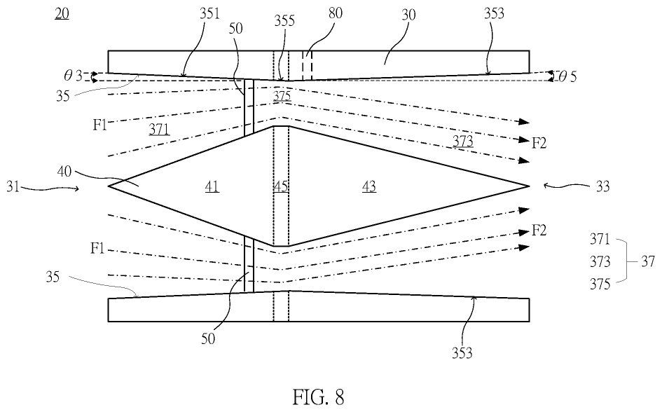

FIG. 8 is a cross-sectional schematic diagram of the spindle flow type nozzle according to another embodiment of the invention. Since the input fluid F1 may mainly undergoes acceleration in the passage 375/675/775 and the diverging space 373, in order to avoid the connecting member 50 from affecting the acceleration of the inlet fluid F1, the connecting member 50 can be positioned within the converging space 371, and connect with the inlet-side inner wall 351 and the first convex body 41.

In one embodiment of the invention, the outlet-side inner wall 353 of the tube body 30 may have an outlet-side thinning angle θ5. The outlet-side thinning angle θ5 extends in a direction away from the center point or centerline of the outlet 33 and/or the tube body 30. Similarly, the diverging space 373 can be formed between the middle section area 355 and the outlet 33 for generating a supersonic outlet fluid F2 at the outlet 33.

The above description is only a preferred embodiment of this disclosure, and is not intended to limit the scope of this disclosure. Modifications should be included within the scope of the patent application of this disclosure.

What is claimed is:

1. A spindle flow type nozzle, comprising:
a tube body comprising an inner wall, an inlet and an outlet, and a accommodating space formed between the inner wall, the inlet and the outlet, wherein the inner wall adjacent to a middle position of the tube body is defined as a middle section area, and an inlet-side inner wall and an outlet-side inner wall are respectively located two sides of the middle section area, wherein the outlet-side inner wall extends from the middle section area towards a center point or a centerline of the outlet at an outlet-side thickening angle; and
a partition member located within the accommodating space of the tube body, the partition member adjacent to a middle position thereof being defined as a middle ring area, and a first convex body and a second convex body respectively located two sides of the middle ring area, wherein the first convex body faces the inlet of the tube body to forms a converging space between the first convex body and the inlet-side inner wall, and a cross-sectional area of the converging space gradually decreases from the inlet towards the outlet, wherein the second convex body faces the outlet of the tube body to form a diverging space between the second convex body and the outlet-side inner wall, and the cross-sectional area of the diverging space gradually increases from the inlet towards the outlet, wherein at least one passage is formed between the middle ring area and the inner wall to connect the converging space and the diverging space.

2. The spindle flow type nozzle according to claim 1, further comprising at least one connecting member to connect the partition member and the inner wall.

3. The spindle flow type nozzle according to claim 1, wherein the first convex body extends from the middle ring area toward the center point or the centerline of the inlet at a first inclined angle, and the second convex body extends from the middle ring area toward the center point or the centerline of the outlet at a second inclined angle, wherein the second inclined angle is greater than the outlet-side thickening angle.

4. The spindle flow type nozzle according to claim 2, wherein the cross-sectional area of the passage is smaller than the cross-sectional area of the converging space and the diverging space.

5. The spindle flow type nozzle according to claim 2, wherein the connecting member connects the middle section area of the inner wall and the middle ring area of the partition member.

6. The spindle flow type nozzle according to claim 2, wherein the connecting member is located within the converging space and connects the inlet-side inner wall and the first convex body.

7. The spindle flow type nozzle according to claim 1, further comprising a fixed ring arranged around an outer side of the partition member, wherein the fixed ring secures to the inner wall, and the passage is provided on the fixed ring.

8. The spindle flow type nozzle according to claim 1, wherein the passage is positioned on the middle section area of the partition member, and penetrates through the partition member, wherein the partition member contacts and secures to the inner wall through the middle section area, and the passage connect to the converging space and the diverging space.

9. The spindle flow type nozzle according to claim 3, wherein the outlet-side thickening angle is from 0 degrees to 10 degrees.

10. The spindle flow type nozzle according to claim 1, wherein the inlet-side inner wall extends from the middle section area of the inner wall toward a direction away from the center point or the centerline of the inlet at an inlet-side thinning angle.

11. A spindle flow type nozzle, comprising:
a tube body comprising an inner wall, an inlet and an outlet, and a accommodating space formed between the inner wall, the inlet and the outlet, wherein the inner wall adjacent to a middle position of the tube body is defined as a middle section area, and an inlet-side inner wall and an outlet-side inner wall are respectively located two sides of the middle section area;
a partition member located within the accommodating space of the tube body, the partition member adjacent to a middle position thereof being defined as a middle ring area, and a first convex body and a second convex body respectively located two sides of the middle ring area, wherein the first convex body faces the inlet of the tube body to forms a converging space between the first convex body and the inlet-side inner wall, and a cross-sectional area of the converging space gradually decreases from the inlet towards the outlet, wherein the second convex body faces the outlet of the tube body to form a diverging space between the second convex body and the outlet-side inner wall, and the cross-sectional area of the diverging space gradually increases from the inlet towards the outlet, wherein at least one passage is formed between the middle ring area and the inner to connect the converging space and the diverging space; and
a connecting member located within the converging space, and connecting the inlet-side inner wall and the first convex body.
